(19) United States
(12) Patent Application Publication
(10) Pub. No.: US 2016/0292480 A1
(43) Pub. Date: Oct. 6, 2016

(54) INFORMATION PROCESSING SYSTEM, INFORMATION PROCESSING APPARATUS, AND INFORMATION PROCESSING METHOD

(71) Applicants: Kouichirou KODAMA, Tokyo (JP); Masaki OKADA, Tokyo (JP); Kyoichi KUWANO, Tokyo (JP)

(72) Inventors: Kouichirou KODAMA, Tokyo (JP); Masaki OKADA, Tokyo (JP); Kyoichi KUWANO, Tokyo (JP)

(73) Assignee: Ricoh Company, Ltd., Tokyo (JP)

(21) Appl. No.: 15/071,827

(22) Filed: Mar. 16, 2016

(30) Foreign Application Priority Data
Mar. 31, 2015 (JP) 2015-072395

(51) Int. Cl. G06K 7/14; G06K 7/10

(52) U.S. Cl. CPC G06K 7/1413; G06K 7/10722

(57) ABSTRACT

An information processing method includes a step of capturing a mark attached to a commodity; a step of decoding the mark captured in the capturing step; a step of transmitting a determination request which includes substance information of a substance registered by a user and identification information of the mark obtained in the step of decoding; a step of receiving a determination response to the determination request; and a step of displaying an image based on image information included in the determination response, the image indicating whether the commodity includes an ingredient which matches the substance information.

### BACKGROUND OF THE INVENTION

1. Field of the Invention

The disclosures herein generally relate to an information processing system, an information processing apparatus, and an information processing method.

2. Description of the Related Art

WO2012/056499 discloses a technique which provides commodity information of commodities in a store in real time using an augmented reality technique. According to the disclosed technique, an augmented reality image for superimposing and displaying obtained commodity information on reality space is generated based on a position of the commodity included in a captured image.

In a case in which component information such as ingredient information of the commodity such as a food item is provided by the augmented reality technique, a person who purchases the food item is required to refer to the ingredient information superimposed and displayed on the food item in order to determine whether to purchase the food item or not. For example, in a case in which the person, who purchases the food item, has food allergy, the person has to refer to the ingredient information super imposed and displayed on the food item in order to determine whether the food item includes an ingredient which is a cause of the food allergy with the greatest care.

Determining whether the food item includes the ingredient which is the cause of the food allergy requires time, labor and a large load for the person who purchases the food item.

Specifically, in a food sales floor of a retail shop, such as a convenience store, a supermarket, a shopping mall, and a department store, it is very difficult to determine whether a foodstuff includes the ingredient which is the cause of the food allergy.

### SUMMARY OF THE INVENTION

It is a general object of at least one embodiment of the present invention to provide an information processing system, an information processing apparatus, and an information processing method that substantially obviate one or more problems caused by the limitations and disadvantages of the related art.

An embodiment of the present invention provides an information processing system including a communication device, a first server and a second server. The communication device includes a capturing unit configured to capture a mark attached to a commodity; a decoding unit configured to decode the mark captured by the capturing unit; a first storage unit configured to store a substance registered by a user; a first transmission and reception unit configured to transmit a determination request and to receive a determination response to the determination request, the determination request including substance information of the substance stored in the first storage unit and identification information of the mark obtained by the decoding unit decoding the mark; and a display control unit configured to display an image based on image information included in the determination response. The first server includes a second storage unit configured to store the identification information of the mark attached to the commodity and ingredient information about an ingredient of the commodity in association with each ingredient information about the ingredient of the commodity from the second storage unit based on the identification information of the mark included in the determination request; a determination unit configured to determine whether the ingredient information about the ingredient of the commodity, which is obtained by the obtaining unit, includes information which matches the substance information included in the determination request; and a transmission unit configured to transmit, to the second server, a determination result determined by the determination unit. The second server includes an image generation unit configured to generate an image which indicates the determination result based on the determination result transmitted from the first server; and a second transmission and reception unit configured to receive the determination result transmitted from the first server and to transmit, to the communication device, the determination response which includes the image information of the image generated by the image generation unit.

An embodiment of the present invention provides an information processing apparatus including a storage unit configured to store identification information of a mark attached to a commodity and ingredient information about an ingredient of the commodity in association with each other; an obtaining unit configured to obtain the ingredient information about the ingredient of the commodity from the storage unit based on the identification information of the mark attached to the commodity included in a determination request transmitted from a communication device; a determination unit configured to determine whether the ingredient information about the ingredient of the commodity, which is obtained by the obtaining unit, includes information which matches substance information about a substance registered by a user included in the determination request; an image generation unit configured to generate an image which indicates a determination result determined by the determination unit based on the determination result; and a transmission and reception unit configured to receive the determination request transmitted from the communication device and to transmit, to the communication device, a determination response which includes image information of the image generated by the image generation unit.

An embodiment of the present invention provides an information processing method including a step of capturing a mark attached to a commodity; a step of decoding the mark captured in the capturing step; a step of transmitting a determination request which includes substance information of a substance registered by a user and identification information of the mark obtained in the step of decoding; a step of receiving a determination response to the determination request; and a step of displaying an image based on image information included in the determination response, the image indicating whether the commodity includes an ingredient which matches the substance information.

### BRIEF DESCRIPTION OF THE DRAWINGS

FIG. 1 is a schematic diagram illustrating an example of an information processing system according to a first embodiment;

FIG. 2 is a block diagram illustrating a hardware configuration of a first server 100 and a second server 200 according to the first embodiment;

FIG. 3 is a block diagram illustrating a hardware configuration of a wireless communication terminal 300 according to the first embodiment;

FIG. 4 is a block diagram illustrating a functional configuration the information processing system according to the first embodiment;

FIG. 5 is a sequence chart illustrating a process of the information processing system according to the first embodiment;

FIG. 6 is drawing illustrating an example of an initial registration guide; and

FIG. 7 is a drawing illustrating an example of a superimposition image.

### DESCRIPTION OF THE PREFERRED EMBODIMENTS

In the following, embodiments of the present invention will be described with reference to the accompanying drawings. It should be noted that in the following embodiment is just an example, and the present invention is not limited to this.

<Information Processing System>

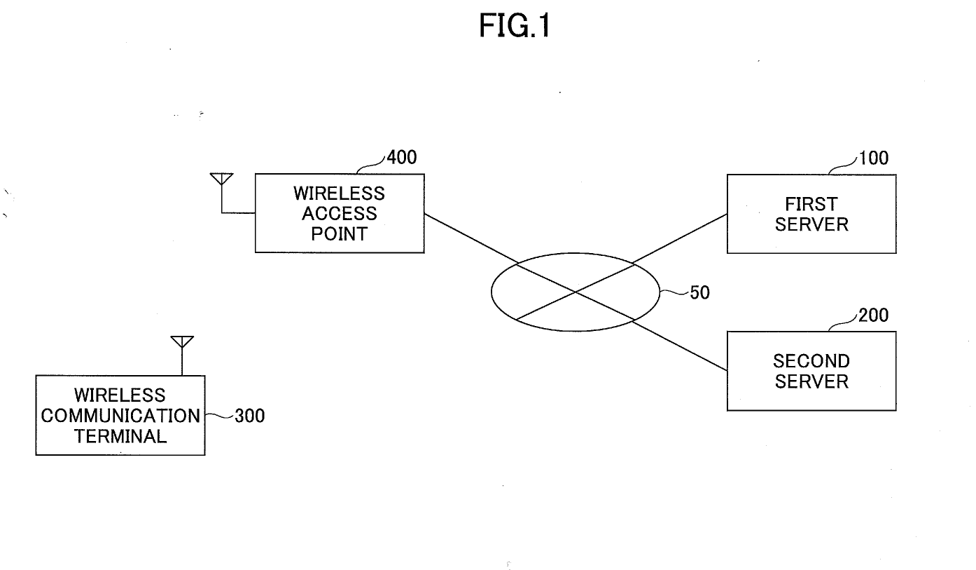

FIG. 1 is a schematic diagram illustrating an example of an information processing system according to a first embodiment. The information processing system includes a first server 100, a second server 200, and a wireless communication terminal 300.

A terminal apparatus such as a personal computer (PC) may be used as the first server 100. The first server 100 receives a captured image of a label attached to a food item (example of a commodity), mark information such as marker ID of an augmented reality (AR) marker (in the following, referred to as the “AR marker”) recognized from the captured image of the label, and information which indicates a prohibited substance (in the following, referred to as the “prohibited substance information”), which are transmitted from an external device such as the wireless communication terminal 300. Here, the marker ID is a mark for designating a position where additional information is displayed on the captured image of the label. Further, the prohibited substance information is information which indicates a substance affecting a human body such as an ingredient which is a cause of a food allergy for a user.

The first server 100 stores, in association with each other, the marker ID, the ingredient included in the food item to which the AR marker for obtaining the marker ID is attached, and the ingredient which is the cause of the food allergy among ingredients. The first server 100 obtains information which indicates the ingredient which is the cause of the food allergy (in the following, referred to as the “allergy information”) based on the marker ID, and determines whether information which matches the prohibited substance information is included in the obtained allergy information.

In a case in which the information, which matches the prohibited substance information, is included in the obtained allergy information, the first server 100 determines that the food item to which the AR marker for obtaining the marker ID, transmitted together with the prohibited substance information, is attached includes the ingredient which is the prohibited substance. Further, in a case in which the information, which matches the prohibited substance information, is not included in the obtained allergy information, the first server 100 determines that the food item to which the AR marker for obtaining the marker ID, transmitted together with the prohibited substance information, is attached does not include the ingredient which is the prohibited substance. The first server 100 transmits, to the second server 200, the information which indicates whether the food item includes the ingredient which is the prohibited substance (in the following, referred to as the “prohibited substance inclusion information”) together with the captured image of the label.

A terminal apparatus such as a personal computer (PC) may be used as the second server 200. The second server 200 generates an augmented reality image to be superimposed on the captured image of the label captured by the wireless communication terminal 300 based on the prohibited substance inclusion information, which indicates whether the food item includes the ingredient which is the prohibited substance, transmitted from the first server 100. The second server 200 transmits, to the wireless communication terminal 300, an image (in the following, referred to as the “superimposition image”) in which the augmented reality image is superimposed on the captured image of the label captured by the wireless communication terminal 300.

A smartphone, a tablet terminal, a wearable device, or a digital camera having a communication function may be used as the wireless communication terminal 300. The wearable device may be a wristwatch type device, a head mount display, AR glasses, smart glasses or the like. The wireless communication terminal 300 stores the prohibited substance information. As described above, the prohibited substance information is information, which indicates the substance affecting the human body such as the ingredient which is the cause of the food allergy for the user, and has been set previously by the user.

The wireless communication terminal 300 recognizes the AR marker from an image captured in a capturing area in response to performing operation of capturing the label attached to the food item, and obtains the image of an AR marker part. The wireless communication terminal 300 decodes the image of the AR marker part to obtain the marker ID. The wireless communication terminal 300 transmits the prohibited substance information together with the obtained marker ID to the first server 100. The wireless communication terminal 300 receives the superimposition image transmitted from the second server 200, and displays the received superimposition image.

A wireless access point 400 constructs a communication channel between the first server 100, the second server 200 and the wireless communication terminal 300. The wireless access point 400 is connected to a communication network 50 such as a local area network (LAN) such as an Ethernet (registered trademark). The wireless access point 400 communicates with the wireless communication terminal 300 according to a standard of the wireless LAN such as IEEE 802.11.

<Hardware Configuration According to the First Embodiment>

Next, a hardware configuration according to the first embodiment will be described.

<First Server 100>

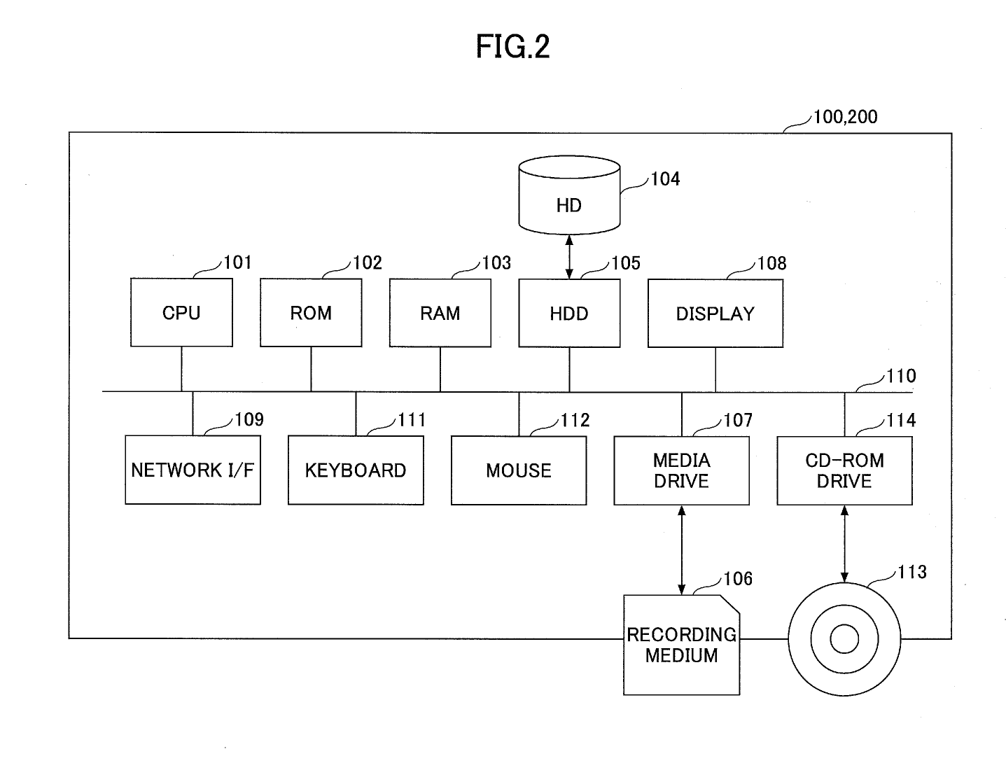

FIG. 2 is a block diagram illustrating a hardware configuration of the first server 100 according to the first embodiment. The first server 100 includes a central processing unit (CPU) 101 which controls the overall operation of the first server 100, a read only memory (ROM) 102 which stores programs used for activating the CPU 101 such as an initial program loader (IPL), and a random access memory (RAM) 103 used as a work space of the CPU 101. Further, the first server 100 includes a HD 104 which stores various kinds of data such as a program for the first server 100, and a hard disk drive (HDD) 105 which controls reading/writing the various kinds of data from/to the HD 104 according to control of the CPU 101. Further, the first server 100 includes a media drive 107 which controls reading/writing (storing) data from/to a recording medium 106 such as a flash memory. Further, the first server 100 includes a display 108 which displays various kinds of information such as a cursor, a menu, a window, a character, and an image, and a network interface (I/F) 109 for transferring the data using the communication network 50. Moreover, the first server 100 has a keyboard 111 which includes a plurality of keys for inputting characters, numeral values, and various instructions, a mouse 112 for selecting and executing various instructions, selecting process objects and moving the cursor, a compact disc read only memory (CD-ROM) drive 114 which controls reading/writing various kinds of data from/to a CD-ROM 113, which is an example of a detachable recording medium, and a bus line 110 such as an address bus and a data bus for electrically connecting elements as shown in FIG. 2.

It should be noted that the above described program for the first server 100 may be stored on a recording medium such as the recording medium 106 and the CD-ROM 113 readable by a computer, and provided (distributed) as a file in an installable form or in an executable form. Further, the above described program for the first server 100 may be stored in the ROM 102 other than the HD 104. The program for the first server 100 includes a prohibited substance inclusion determination application (for the first server 100) for determining whether the food item includes the prohibited substance such as the food allergy substance.

Further, because the second server 200 includes a hardware configuration similar to the hardware configuration of the first server 100, its description is omitted as appropriate. It should be noted that the HD 104 stores a program for the second server 200 for controlling the second server 200. In this case also, the program for the second server 200 may be stored on a recording medium such as the recording medium 106 and the CD-ROM 113 readable by a computer, and provided as a file in an installable form or in an executable form. Further, the program for the second server 200 may be stored in the ROM 102 other than the HD 104. The program for the second server 200 includes a prohibited substance inclusion determination application (for the second server 200) for determining whether the food item includes the prohibited substance such as the food allergy substance.

<Wireless Communication Terminal 300>

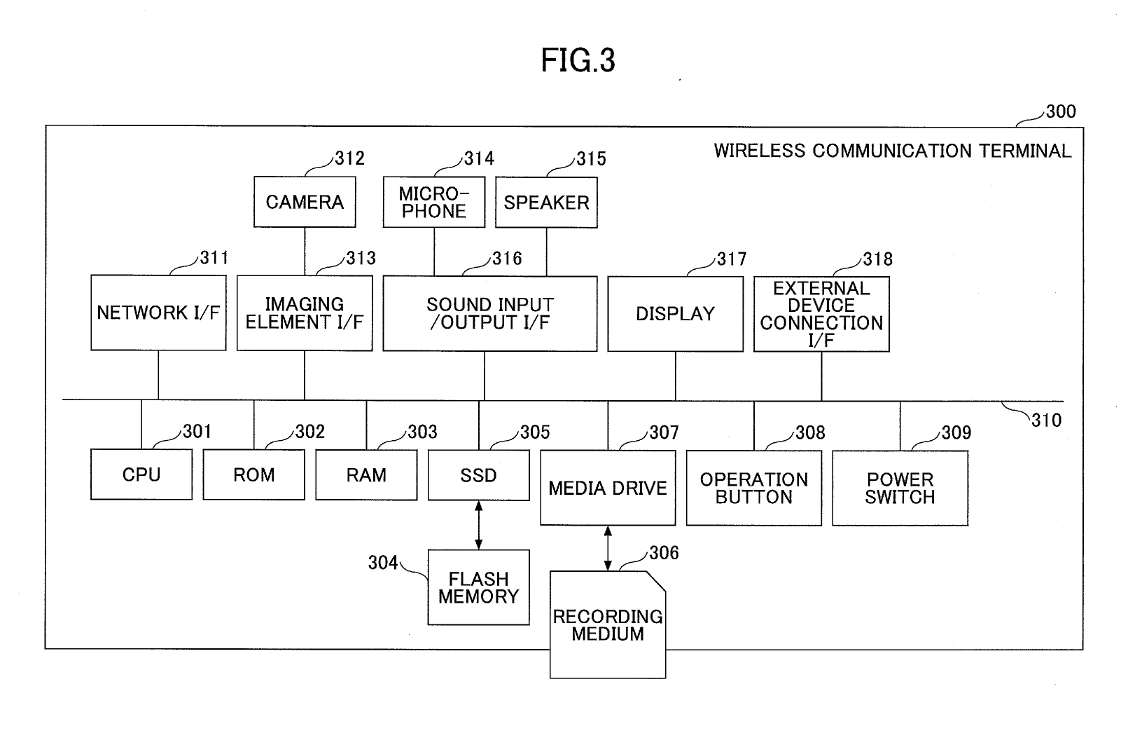

FIG. 3 is a block diagram illustrating a hardware configuration of the wireless communication terminal 300 according to the first embodiment. As shown in FIG. 3, the wireless communication terminal 300 according to the first embodiment includes a CPU 301 which controls the overall operation of the wireless communication terminal 300, and a ROM 302 which stores programs used for activating the CPU 301 such as an IPL. Further, the wireless communication terminal 300 includes a RAM 303 used as a work space of the CPU 301, a flash memory 304 which stores various kinds of data such as a program for the wireless communication terminal 300, image data, and sound data, and a solid state drive (SSD) 305 which controls reading/writing the various kinds of data from/to the flash memory 304 according to control of the CPU 301. Further, the wireless communication terminal 300 includes a media drive 307 which controls reading/writing (storing) data from/to a recording medium 306 such as a flash memory. Moreover, the wireless communication terminal 300 includes an operation button 308 operated for selecting a destination of the wireless communication terminal 300, a power source switch 309 for switching a power source of the wireless communication terminal 300 between an ON state and an OFF state, and a network interface (I/F) 311 for transferring the data using the communication network 50.

Further, the wireless communication terminal 300 includes a built-in camera 312 which captures an object according to control of the CPU 301 to obtain image data; an imaging element I/F 313 which controls driving the camera 312; a built-in microphone 314 which inputs sound; a built-in speaker 315 which outputs sound; a sound input/output I/F 316, which performs an inputting/outputting process of a voice signal between the microphone 314 and the speaker 315 according to the control by the CPU 301; a display 317 which displays various kinds of information such as a cursor, a menu, a window, a character, and an image; an external device connection I/F 318 for connecting various external devices to the wireless communication terminal 300; and a bus line 310 such as an address bus and a data bus for electrically connecting elements as shown in FIG. 3.

The camera 312 includes a lens and solid-state image elements, which convert light into electric charges to obtain digital data of an image (video) of an object. For the solid-state image elements, for example, a CMOS (complementary metal oxide semiconductor), a CCD (charge coupled device), or the like is used.

External devices such as an external camera, an external microphone and an external speaker may be connected to the external device connection I/F 318 via a USB (Universal Serial Bus) cable or the like. In a case in which the external camera is connected, with priority over the built-in camera 312, the external camera is activated according to the control by the CPU 301. Similarly, in a case in which the external microphone is connected or the external speaker is connected, with priority over the built-in microphone 314 or the built-in speaker 315, respectively, the external microphone or the external speaker is activated according to the control by the CPU 301.

It should be noted that the recording medium 306 is attachable/detachable to/from the wireless communication terminal 300. If the recording medium 306 is a non-volatile memory, from which data are read, or into which data are written according to the control by the CPU 301, not only the flash memory 304, but also EEPROM (electrically erasable and programmable ROM) or the like may be used.

Moreover, the program for the wireless communication terminal 300 may be stored on a recording medium such as the recording medium 306 readable by a computer, and provided (distributed) as a file in an installable form or in an executable form. The above described program for the wireless communication terminal 300 may be stored in the ROM 302 other than the flash memory 304. The above described program for the wireless communication terminal 300 includes a prohibited substance inclusion determination application (for the wireless communication terminal 300) for determining whether the food item includes the prohibited substance such as the food allergy substance.

<Functional Configuration of the Information Processing System>

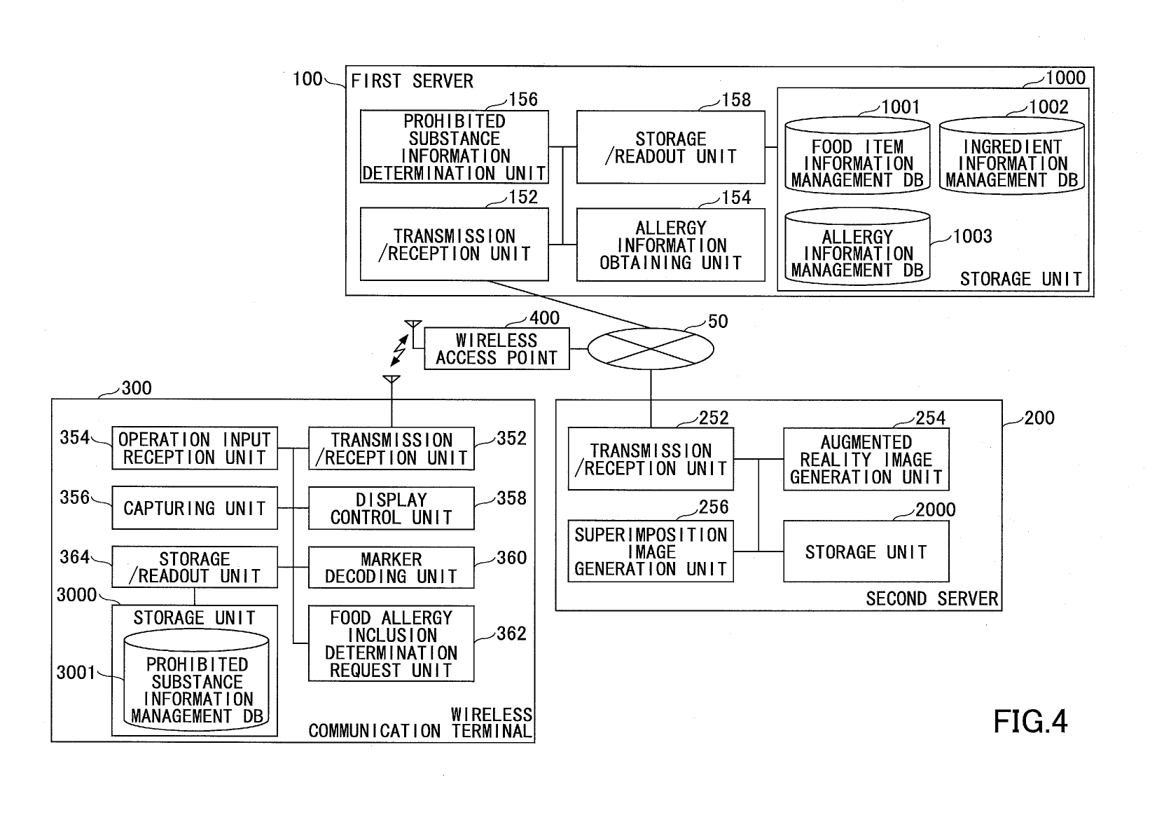

Next, a functional configuration of the information processing system according to the first embodiment will be described. FIG. 4 is a block diagram illustrating functional configurations of the first server 100, the second server 200, and the wireless communication terminal 300, which form the information processing system according to the first embodiment. In FIG. 4, the first server 100, the second server 200, and the wireless communication terminal 300 are connected in order to communicate with each other via the communication network 50.

<Functional Configuration of the First Server 100>

The first server 100 includes a transmission/reception unit 152, an allergy information obtaining unit 154, a prohibited substance information determination unit 156, and a storage/readout unit 158. Each of the above units is a function or a function means realized by one of the elements, shown in FIG. 2, operating according to an instruction from the CPU 101 following the program for the first server 100 held in the RAM 103 from the HD 104. Further, the first server 100 includes a storage unit 1000 structured with at least one of the ROM 102 and the HD 104 shown in FIG. 2.

(Food Item Information Management Table)

In the first storage unit 1000, a food item information management DB 1001 which includes a food item information management table as shown in a table 1 is structured.

TABLE 1

| MARKER ID | FOOD ITEM NAME | FOOD ITEM ID |
|---|---|---|
| M0001 | AAAA | S0001 |
| M0002 | BBBB | S0002 |
| . . . | . . . | . . . |

In the food item information management table, a food name and food item ID, which is identification information of the food item, are managed in association with the marker ID of the AR marker included in the label attached to the food item. For example, in the food item information management table shown in the table 1, the food name of the marker ID “M0001” is “AAAA”, and the food item ID of the marker ID “M0001” is “S0001”.

(Ingredient Information Management Table)

In the first storage unit 1000, an ingredient information management DB 1002 which includes ingredient information management tables as shown in tables 2 and 3 is structured.

TABLE 2

| FOOD ITEM ID | INGREDIENT NAME | INGREDIENT ID |
|---|---|---|
| S0001 | PEANUT | g0001 |
| S0001 | EDIBLE FAT AND OIL | g0002 |
| S0001 | SOYBEAN | g0003 |
| S0001 | SALT | g0004 |
| S0001 | RICE | g0005 |
| . . . | . . . | . . . |

TABLE 3

| FOOD ITEM ID | INGREDIENT NAME | INGREDIENT ID |
|---|---|---|
| S0002 | RICE | g0005 |
| S0002 | EDIBLE FAT AND OIL | g0002 |
| S0002 | STARCH | g0006 |
| S0002 | SUGAR | g0009 |
| . . . | . . . | . . . |

In the ingredient information management tables, an ingredient name and ingredient ID, which is identification information of the ingredient, are managed in association with the food item ID. For example, in the ingredient information management table shown in the table 2, the ingredient names of the food item ID “S0001” are “PEANUT”, “EDIBLE FAT AND OIL” “SOYBEAN” “SALT”, “RICE”, and the like. Further, the ingredient ID of the ingredient name “PEANUT” is “g0001”, the ingredient ID of the ingredient name “EDIBLE FAT AND OIL” is “g0002”, the ingredient ID of the ingredient name “SOYBEAN” is “g0003”, the ingredient ID of the ingredient name “SALT” is “g0004”, and the ingredient ID of the ingredient name “RICE” is “g0005”. Further, in the ingredient information management table shown in the table 3, the ingredient names of the food item ID “S0002” are “RICE”, “EDIBLE FAT AND OIL” “STARCH”, “SUGAR” and the like. Further, the ingredient ID of the ingredient name “RICE” is “g0005”, the ingredient ID of the ingredient name “EDIBLE FAT AND OIL” is “g0002”, the ingredient ID of the ingredient name “STARCH” is “g0006”, and the ingredient ID of the ingredient name “SUGAR” is “g0009”.

(Allergy Information Management Table)

In the first storage unit 1000, an allergy information management DB 1003 which includes an allergy information management table as shown in tables 4 and 5 is structured.

TABLE 4

| FOOD ITEM ID | ALLERGY NAME | ALLERGY ID |
|---|---|---|
| S0001 | EGG | a0001 |
| S0001 | MILK | a0002 |
| S0001 | WHEAT | a0003 |
| S0001 | SHRIMP | a0004 |
| . . . | . . . | . . . |

TABLE 5

| FOOD ITEM ID | ALLERGY NAME | ALLERGY ID |
|---|---|---|
| S0002 | EGG | a0001 |
| S0002 | MILK | a0002 |
| S0002 | WHEAT | a0003 |
| S0002 | SHRIMP | a0004 |
| . . . | . . . | . . . |

In the allergy information management tables, allergy names, each of which indicates an allergy included in the food item associated with the food item ID, and allergy IDs, each of which is identification information of the allergy, are managed in association with the corresponding food item IDs. For example, in the allergy information management table shown in the table 4, the allergy names associated with the food item ID “S0001” are “EGG”, “MILK” “WHEAT”, “SHRIMP” and the like. Further, the allergy ID of the allergy name “EGG” is “a0001”, the allergy ID of the allergy name “MILK” is “a0002”, the allergy ID of the allergy name “WHEAT” is “a0003”, and the allergy ID of the allergy name “SHRIMP” is “a0004”.

Further, for example, in the allergy information management table shown in the table 5, the allergy names associated with the food item ID “S0002” are “EGG”, “MILK”, “WHEAT”, “SHRIMP” and the like. Further, the allergy ID of the allergy name “EGG” is “a0001”, the allergy ID of the allergy name “MILK” is “a0002”, the allergy ID of the allergy name “WHEAT” is “a0003”, and the allergy ID of the allergy name “SHRIMP” is “a0004”.

(Each of the Functional Elements of the First Server 100)

Next, each of the functional elements of the first server 100 will be described in detail. In the description below, when each of the functional elements of the first server 100 is described, the relationship with main elements for realizing each of the functional elements of the first server 100 among the functional elements shown in FIG. 2 will also be described.

The transmission/reception unit 152 of the first server 100 shown in FIG. 4 is realized by the instruction from the CPU 101 shown in FIG. 2 and the network I/F 109 shown in FIG. 2, and transmits/receives various kinds of data (or information) to/from the second server 200 or the wireless communication terminal 300 via the communication network 50. For example, according to communication standards of a cellular phone such as a third-generation cellular phone (3G) and a fourth-generation cellular phone (4G) or standards of a wireless local area network (LAN) such as wireless fidelity (WiFi), the transmission/reception unit 152 may wirelessly transmit/receive the various kinds of data (or information) to/from the second server 200 or the wireless communication terminal 300 via the communication network 50. Further, the transmission/reception unit 152 may transmit/receive the various kinds of data (or information) to/from the second server 200 or the wireless communication terminal 300 via the communication network 50 and a wire.

The allergy information obtaining unit 154 is realized by the instruction from the CPU 101 shown in FIG. 2, and obtains the allergy information based on the marker ID transmitted from the wireless communication terminal 300. When obtaining the allergy information, the allergy information obtaining unit 154 refers to the food item information management table, stored in the food item information management DB 1001, to obtain the food item ID associated with the marker ID. Further, the allergy information obtaining unit 154 refers to the ingredient information management table, stored in the ingredient information management DB 1002, to obtain the ingredient ID associated with the food item ID. Further, the allergy information obtaining unit 154 refers to the allergy information management table, stored in the allergy information management DB 1003, to obtain the allergy ID associated with the ingredient ID. The allergy information obtaining unit 154 inputs the allergy ID into the prohibited substance information determination unit 156.

The prohibited substance information determination unit 156 is realized by the instruction from the CPU 101 shown in FIG. 2, and determines whether one or more the allergy IDs input by the allergy information obtaining unit 154 match the prohibited substance information transmitted by the wireless communication terminal 300. In a case in which the one or more allergy IDs match the prohibited substance information, the prohibited substance information determination unit 156 determines that the food item, to which the AR marker for obtaining the marker ID transmitted with the prohibited substance information is attached, includes the ingredient which is the prohibited substance. Further, in a case in which none of allergy IDs matches the prohibited substance information, the prohibited substance information determination unit 156 determines that the food item, to which the AR marker for obtaining the marker ID transmitted with the prohibited substance information attached, does not include the ingredient which is the prohibited substance. The prohibited substance information determination unit 156 transmits, to the second server 200 from the transmission/reception unit 152, the prohibited substance inclusion information, which indicates whether the food item includes the ingredient which is the prohibited substance, together with the captured image of the label.

The storage/readout unit 158 is realized by the instruction from the CPU 101 shown in FIG. 2 and the HDD 105 shown in FIG. 2. The storage/readout unit 158 stores various kinds of data into the storage unit 1000 and performs a process for reading out the various kinds of data stored in the storage unit 1000.

<Functional Configuration of the Second Server 200>

The second server 200 includes a transmission/reception unit 252, an augmented reality image generation unit 254, and a superimposition image generation unit 256. Each of the above units is a function or a function means realized by one of the elements, shown in FIG. 2, operating according to an instruction from the CPU 101 following the program for the second server 200 held in the RAM 103 from the HD 104. Further, the second server 200 includes a storage unit 2000 structured with at least one of the RAM 103 and the HD 104 shown in FIG. 2.

(Each of the Functional Elements of the Second Server 200)

Next, each of the functional elements of the second server 200 will be described in detail. In the description below, when each of the functional elements of the second server 200 is described, the relationship with main elements for realizing each of the functional elements of the second server 200 among the functional elements shown in FIG. 2 will also be described.

The transmission/reception unit 252 of the second server 200 shown in FIG. 4 is realized by the instruction from the CPU 101 shown in FIG. 2 and the network I/F 109 shown in FIG. 2, and transmits/receives various kinds of data (or information) to/from the first server 100 or the wireless communication terminal 300 via the communication network 50. For example, according to the communication standards of the cellular phone such as the 3G and 4G or the standards of the wireless local area network (LAN) such as the wireless fidelity (WiFi), the transmission/reception unit 252 may wirelessly transmit/receive the various kinds of data (or information) to/from the second server 200 or the wireless communication terminal 300 via the communication network 50. Further, the transmission/reception unit 252 may transmit/receive the various kinds of data (or information) to/from the second server 200 or the wireless communication terminal 300 via the communication network 50 and a wire.

The augmented reality image generation unit 254 is realized by the instruction from the CPU 101 shown in FIG. 2, and generates an augmented reality image to be superimposed on an image of the food item based on the prohibited substance inclusion information transmitted by the first server 100. The augmented reality image generation unit 254 inputs the augmented reality image in the superimposition image generation unit 256. For example, in a case in which the prohibited substance inclusion information indicates that the prohibited substance is included, the augmented reality image generation unit 254 generates the augmented reality image for prompting the user to recognize instinctively that the food item includes the prohibited substance. Specifically, the augmented reality image generation unit 254 can generate an image “x” or “NG” as the augmented reality image for prompting the user to recognize instinctively that the food item includes the prohibited substance. Further, in a case in which the prohibited substance inclusion information indicates that the prohibited substance is not included, the augmented reality image generation unit 254 generates, for example, the augmented reality image for prompting the user to recognize instinctively that the food item does not include the prohibited substance. Specifically, the augmented reality image generation unit 254 can generate an image “o” or “OK” as the augmented reality image for prompting the user to recognize instinctively that the food item does not include the prohibited substance. The augmented reality image generation unit 254 may change the augmented reality image for prompting the user to recognize instinctively whether the food item includes the prohibited substance in accordance with a language which the user uses and a country.

The superimposition image generation unit 256 is realized by the instruction from the CPU 101 shown in FIG. 2, and superimposes the augmented reality image, input by the augmented reality image generation unit 254, on the captured image of the label, input by the transmission/reception unit 252, to generate the superimposition image. The superimposition image generation unit 256 transmits the superimposition image from the transmission/reception unit 252 to the wireless communication terminal 300.

<Functional Configuration of the Wireless Communication Terminal 300>

The wireless communication terminal 300 includes a transmission/reception unit 352, an operation input reception unit 354, a capturing unit 356, a display control unit 358, a marker decoding unit 360, a food allergy inclusion determination request unit 362, and a storage/readout unit 364. Each of the above units is a function or a function means realized by one of the elements, shown in FIG. 3, operating according to an instruction from the CPU 301 following the program for the wireless communication terminal 300 held in the RAM 303 from the flash memory 304. Further, the wireless communication terminal 300 includes a storage unit 3000 structured with the flash memory 304 shown in FIG. 3.

(Prohibited Substance Information Management Table)

In the storage unit 3000, a prohibited substance information management DB 3001 which includes a prohibited substance information management table shown in a table 6 is structured.

TABLE 6

| | | PROHIBITION |
|---|---|---|
| ALLERGY NAME | ALLERGY ID | STATUS |
| EGG | a0001 | PERMIT |
| MILK | a0002 | PROHIBIT |
| WHEAT | a0003 | PERMIT |
| SHRIMP | a0004 | PERMIT |
| CRAB | a0005 | PERMIT |
| . . . | . . . | . . . |

In the prohibited substance information management table, prohibition statuses are managed in association with the allergy names and the allergy IDs, which are identification information of the allergy. The prohibited status indicates whether the substance is the ingredient which is the cause of the food allergy for the user. For example, in the prohibition substance information management table shown in the table 6, the allergy ID of the allergy name “EGG” is “a0001”, and the prohibition status of the allergy name “EGG” is “PERMIT”. The “PERMIT” indicates that the substance is not the ingredient which is the cause of the food allergy for the user.

(Each of the Functional Elements of the Wireless Communication Terminal 300)

Next, each of the functional elements of the wireless communication terminal 300 will be described in detail. In the description below, when each of the functional elements of the wireless communication terminal 300 is described, the relationship with main elements for realizing each of the functional elements of the wireless communication terminal 300 among the functional elements shown in FIG. 3 will also be described.

The transmission/reception unit 352 of the wireless communication terminal 300 shown in FIG. 4 is realized by the instruction from the CPU 301 shown in FIG. 3 and the network I/F 311 shown in FIG. 3, and transmits/receives various kinds of data (or information) to/from the first server 100 or the second server 200 via the communication network 50. For example, according to the communication standards of the cellular phone such as the 3G and 4G, or the standards of the wireless local area network (LAN) such as the wireless fidelity (WiFi), the transmission/reception unit 352 may wirelessly transmit/receive the various kinds of data (or information) to/from the first server 100 or the second server 200 via the communication network 50. Further, the transmission/reception unit 352 may transmit/receive the various kinds of data (or information) to/from the second server 200 or the wireless communication terminal 300 via the communication network 50 and a wire.

The operation input reception unit 354 is realized by the instruction from the CPU 301 shown in FIG. 3, the operation button 308, and the power source switch 309 shown in FIG. 3, and receives various kinds of input from the user. For example, the operation input reception unit 354 receives an operation for downloading or installing the prohibited substance inclusion determination application. Further, the operation input reception unit 354 receives an operation for starting the prohibited substance inclusion determination application. Moreover, for example, the operation input reception unit 354 receives an operation for registering the prohibited substance information. That is, the storage unit 300 can store the substance(s), registered by the user, prohibited from being taken in.

The capturing unit 356 is realized by the instruction from the CPU 301 shown in FIG. 3, the camera 312 and the imaging element I/F 313 shown in FIG. 3. The capturing unit 356 captures an object and outputs image data obtained by capturing the object. The capturing unit 356 starts operating in response to starting the prohibited substance inclusion determination application. When the operation for capturing the label attached to the food item is performed, the capturing unit 356 recognizes the AR marker from the image captured in the capturing area, and obtains the image of the AR marker part. The capturing unit 356 inputs the image of the AR marker part in the marker decoding unit 360.

The display control unit 358 is realized by the instruction from the CPU 301 shown in FIG. 3, and the display 317 shown in FIG. 3. The display control unit 358 performs control for displaying the label attached to the food item when the capturing unit 356 captures the object, and performs control for displaying the superimposition image transmitted from the second server 200 in the display 317.

The marker decoding unit 360 is realized by the instruction from the CPU 301 shown in FIG. 3. The marker decoding unit 360 recognizes the AR marker from the image of the AR marker part input by the capturing unit 356, and decodes the recognized AR marker to obtain the marker ID.

The food allergy inclusion determination request unit 362 is realized by the instruction from the CPU 301 shown in FIG. 3.

After the prohibited substance inclusion determination application is started in response to an event in which the operation input reception unit 354 receives a request for starting the prohibited substance inclusion determination application by the user operating the operation button 308, the food allergy inclusion determination request unit 362 requests food allergy inclusion determination (request for determining inclusion of food allergy). Specifically, the food allergy inclusion determination request unit 362 obtains the captured image of the label from the capturing unit 356, and obtains the marker ID from the marker decoding unit 360. Further, the food allergy inclusion determination request unit 362 causes the storage/readout unit 364 to read out the prohibited substance information management table, stored in the prohibited substance information management DB 3001 of the storage unit 3000, to obtain the prohibited substance information. The food allergy inclusion determination request unit 362 transmits, to the first server 100, the captured image of the label, the marker ID, and the prohibited substance information to request the first server 100 to determine whether the food item, to which the label is attached, includes the prohibited substance. The food allergy inclusion determination request unit 362 obtains the superimposition image transmitted from the second server 200 as a response to the request, and causes the display control unit 358 to display the superimposition image.

<Operation of the Information Processing System>

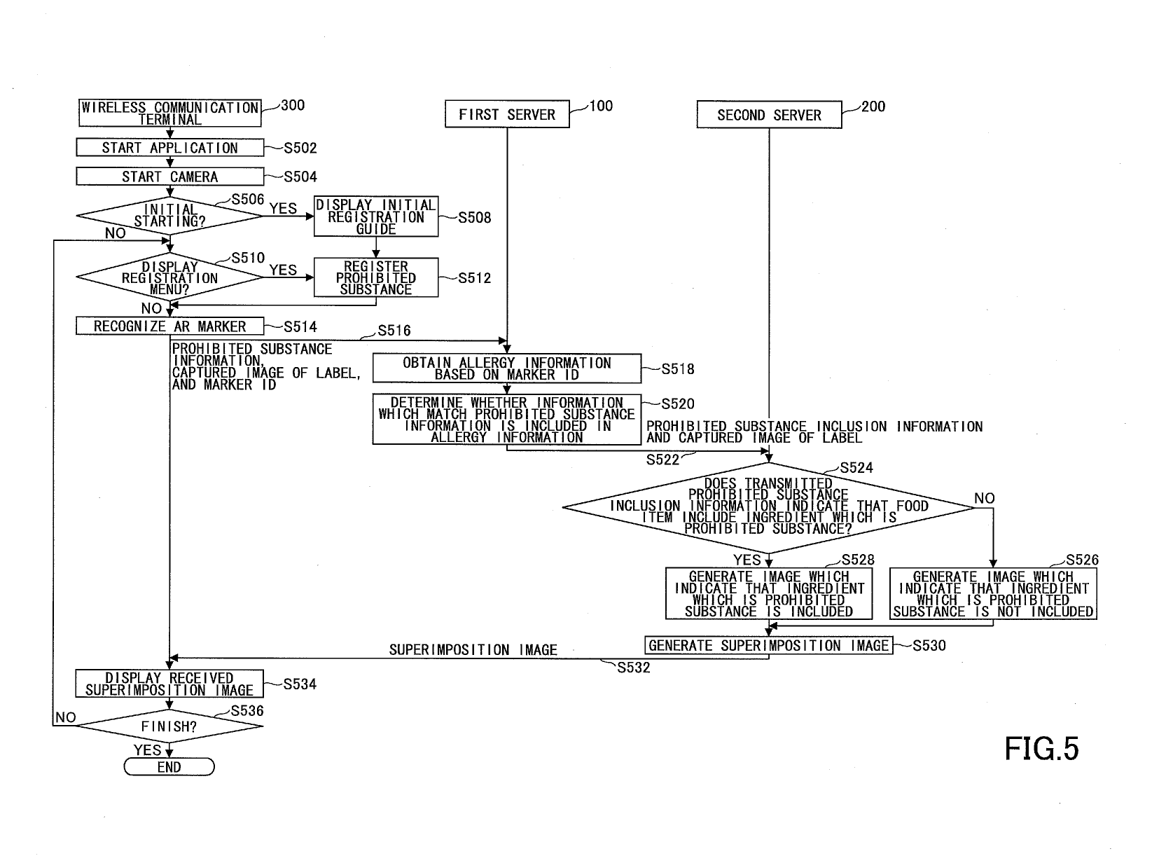

FIG. 5 is a sequence chart illustrating a process of the information processing system according to the first embodiment.

When the user operates the operation button 308 of the wireless communication terminal 300 for starting the prohibited substance inclusion determination application, the operation input reception unit 354 shown in FIG. 4 receives a request of the food allergy inclusion determination in step S502.

In response to receiving the request of the food allergy inclusion determination, the operation input reception unit 354 transmits (requests) the request of the food allergy inclusion determination to the food allergy inclusion determination request unit 362. In response to the request of the food allergy inclusion determination requested by the operation input reception unit 354, the food allergy inclusion determination request unit 362 causes the capturing unit 356 to start the camera 312 in step S504.

In step S506, the food allergy inclusion determination request unit 362 determines whether starting the application is initial starting.

In a case in which the food allergy inclusion determination request unit 362 determines that starting the application is the initial starting (YES in step S506), the food allergy inclusion determination request unit 362 causes the display control unit 358 to display an initial registration guide in step S508.

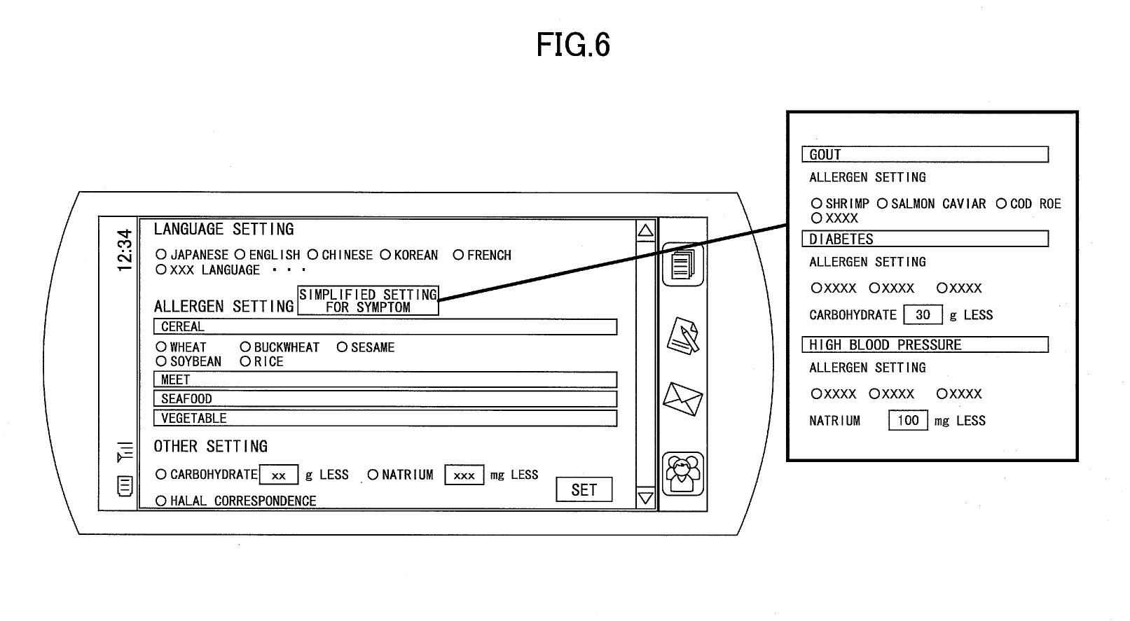

FIG. 6 is a drawing illustrating an example of the initial registration guide. A language setting field (setting unit) for setting a language is arranged in the initial registration guide. In the language setting field, radio buttons are associated with corresponding languages including the Japanese language, the English language, the Chinese language, the Korean language, the French language, and the like. The language to be used (displayed) can be set by selecting one of the radio buttons. Further, an allergen setting field for setting the prohibited substance information such as allergens is arranged in the initial registration guide. In the allergen setting field, allergens are classified into corresponding categories such as cereal, meat, seafood, and vegetable. For example, wheat, buckwheat, sesame, soybean, and rice are classified in the category of the cereal. Further, radio buttons are associated with corresponding allergens belonging to the categories. The prohibited substance can be set by selecting one of the radio buttons. Moreover, a permissible quantity for the prohibited substance may be set in the initial registration guide. In this way, based on whether an inclusion quantity of the prohibited substance is equal to or greater than the permissible quantity, whether the food item includes the ingredient which is the prohibited substance can be determined. Further, a warning for the user may be performed in a case in which an intake quantity of the prohibited substance approaches the permissible quantity. Moreover, prohibited substances not desired to be eaten individually or familially may be set in the initial registration guide. In this way, halal can be coped with.

Moreover, in the example shown in FIG. 6, a “SIMPLIFIED SETTING FOR SYMPTOM” button for setting the prohibited substance in accordance with conditions of the user such as “GOUT” and “HIGH BLOOD PRESSURE” is arranged. When the “SIMPLIFIED SETTING FOR SYMPTOM” button is pushed, together with the condition of the user such as the “GOUT”, and the “HIGH BLOOD PRESSURE”, a field for setting candidates of the prohibited substances corresponding to the condition of the user and the permissible quantity of the prohibited substance is displayed. The user can set the one or more prohibited substances among the candidates of the prohibited substances, and the permissible quantity of that. In this way, the allergen, and the permissible quantity of the prohibited substance can be set based on the condition of the user.

In a case in which the food allergy inclusion determination request unit 362 determines that starting the application is not the initial starting (NO in step S506), the food allergy inclusion determination request unit 362 determines whether to cause the display control unit 358 to display the initial registration guide (registration menu) in step S510.

After causing the display control unit 358 to display the initial registration guide in step S508, or determining to cause the display control unit 358 to display the initial registration guide in step S510, the food allergy inclusion determination request unit 362 causes the user to register the prohibited substance(s) in step S512. The food allergy inclusion determination request unit 362 causes the storage/readout unit 364 to store the prohibited substance(s) registered by the user in the prohibited substance information management table of the prohibited substance information management DB 3001.

When the user directs (turns) the camera 312 to capture the label, which is attached to the food item, as the object, the capturing unit 356 of the wireless communication terminal 300 recognizes the AR marker from the image captured in the capturing area, and the marker decoding unit 360 obtains the marker ID of the recognized AR marker in step S514.

The food allergy inclusion determination request unit 362 of the wireless communication terminal 300 causes the storage/readout unit 364 to obtain the prohibited substance information stored in the prohibited substance information management table of the prohibited substance information management DB 3001 of the storage unit 3000. Moreover, the food allergy inclusion determination request unit 362 causes the transmission/reception unit 352 to transmit, to the first server 100, the prohibited substance information, the captured image of the label, and the marker ID in step S516.

The transmission/reception unit 152 of the first server 100 receives the prohibited substance information, the captured image of the label, and the marker ID, transmitted from the wireless communication terminal 300. The allergy information obtaining unit 154 obtains the allergy information based on the marker ID in step S518.

In step S520, the prohibited substance information determination unit 156 of the first server 100 determines, based on the prohibited substance information received by the transmission/reception unit 152 and the allergy information obtained by the allergy information obtaining unit 154, whether information which matches the prohibited substance information is included in the allergy information. In step S522, the first server 100 transmits, to the second server 200, the prohibited substance inclusion information together with the captured image of the label.

The transmission/reception unit 252 of the second server 200 receives the captured image of the label, and the prohibited substance inclusion information, transmitted from the first server 100. In step S524, the augmented reality image generation unit 254 determines whether the transmitted prohibited substance inclusion information indicates that the food item includes the ingredient which is the prohibited substance.

In a case in which the prohibited substance inclusion information indicates that the food item does not include the ingredient which is the prohibited substance (NO in step S524), the augmented reality image generation unit 254 generates in step S526 an image which indicates that the ingredient which is the prohibited substance is not included.

In a case in which the prohibited substance inclusion information indicates that the food item includes the ingredient which is the prohibited substance (YES in step S524), the augmented reality image generation unit 254 generates in step S528 an image which indicates that the ingredient which is the prohibited substance is included.

The superimposition image generation unit 256 generates the superimposition image in step S530 by superimposing the image generated in step S526, which indicates that the ingredient which is the prohibited substance is not included, or the image generated in step S528, which indicates that the ingredient which is the prohibited substance is included, on the captured image of the label.

The transmission/reception unit 252 of the second server 200 transmits the superimposition image to the wireless communication terminal 300 in step S532. That is, the transmission/reception unit 252 transmits, to the wireless communication terminal 300, the superimposition image in which the image, which indicates that the ingredient which is the prohibited substance is not included, or the image, which indicates that the ingredient which is the prohibited substance is included, is superimposed on the captured image of the label which has been received from the wireless communication terminal 300 via the first server 100. In this way, in comparison with a case in which information, which indicates that the ingredient which is the prohibited substance is not included, or information, which indicates that the ingredient which is the prohibited substance is included, is transmitted from the second server 200 to the wireless communication terminal 300, reliability can be improved.

In response to an event in which the transmission/reception unit 352 of the wireless communication terminal 300 receives the superimposition image transmitted from the second server 200, the display control unit 358 displays the received superimposition image in the display 317 in step S534.

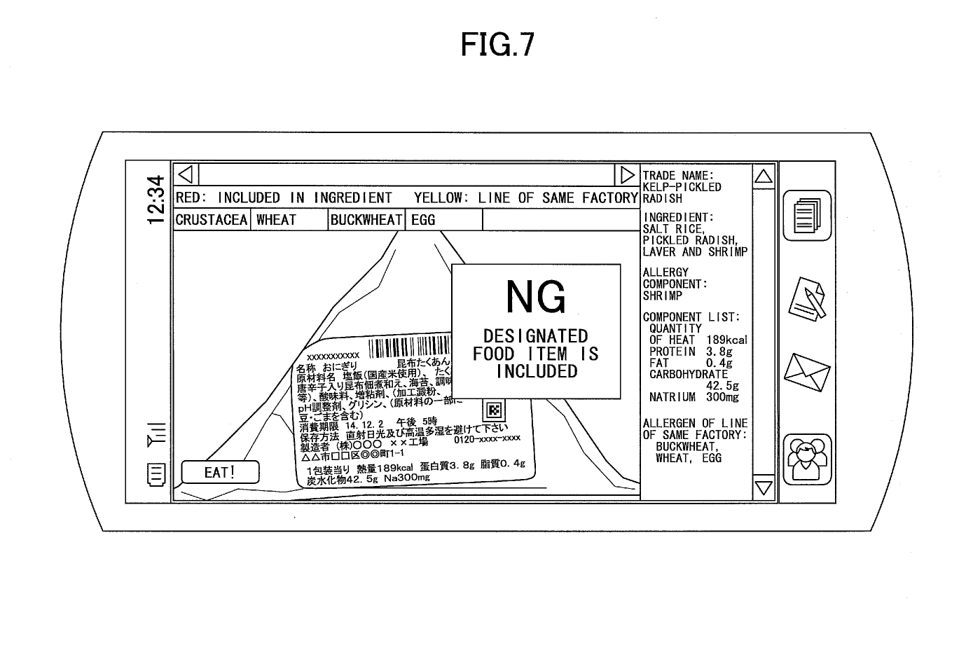

FIG. 7 is a drawing illustrating an example of the superimposition image. In the example shown in FIG. 7, an image is displayed in which the image (“NG”), which indicates that the ingredient which is the prohibited substance is included, is superimposed on the captured image of the label. The displayed image, which indicates that the ingredient which is based on the language registered in step S508. In this case, the English language has been selected, and a commodity sold in Japan is captured. Moreover, in the example shown in FIG. 7, a trade name (“KELP-PICKLED RADISH”), ingredients (“SALT RICE”, “PICKLED RADISH”, “LAVER” and “SHRIMP”), an ingredient which is the prohibited substance (“SHRIMP”), and ingredients (“WHEAT”, “BUCKWHEAT” and “EGG”) which are the prohibited substances among ingredients of food items manufactured in manufacturing lines of the same factory as the factory of the food item (“KELP-PICKLED RADISH”) are displayed. In this way, by tracing a channel of distribution of the food item from a production stage to a final consumption phase, whether the ingredient which is the prohibited substance is included can be notified (reported).

In step S536, the wireless communication terminal 300 determines whether operation for finishing, performed by the user operating the operation button 308, is performed. In a case in which the operation for finishing is performed (YES in step S536), the process ends. In a case in which the operation for finishing has not been performed (NO in step S536), the process returns to step S510.

In the information processing system according to the first embodiment, the wireless communication terminal 300 may store history information of the marker ID of the AR marker attached to the selected food item. Then, in a case in which the marker ID of the AR marker attached to the food item, about which the food allergy inclusion request is requested by the user, is included in the history information of the marker ID, the wireless communication terminal 300 may display information which indicates that the food item has been selected previously without transmitting, to the first server, the prohibited substance information, the captured image of the label, and the marker ID. At this time, the wireless communication terminal 300 may also display information which indicates that a determination result of the previous time about the food item included in the history information of the marker ID. In this way, notifying the user can be performed promptly and a processing load of the information processing system can be reduced.

In the information processing system according to the first embodiment, the wireless communication terminal 300 may accumulate information of component quantity of the prohibited substance with regard to the selected food item. In this way, the wireless communication terminal 300 can warn the user when the accumulated component quantity of the prohibited substance approaches the permissible quantity.

In the information processing system according to the first embodiment, the superimposition image is displayed in which the image which indicates whether the ingredient which is the prohibited substance is included is superimposed on the captured image of the label of the food item. In this way, the information processing system can notify the person, who purchases the food item, of whether the ingredient which is the prohibited substance is included instinctively to support the purchase. That is, the person who has food allergy can instinctively recognizes that the food item which includes the ingredient which is the prohibited substance which causes the food allergy. In this way, a purchase process can be significantly streamlined, supporting customers and differentiating food items can be achieved. Further, the user can purchase the food item at ease.

Moreover, because the information processing system can cope with the plurality of languages, a person from another country can instinctively recognizes that the food item which includes the ingredient which is the prohibited substance which causes the food allergy.

<First Variation of the First Embodiment>

The above described first embodiment can be applied to an information processing system according to a first variation.

In the information processing system according to the first variation, the capturing unit 356 of the wireless communication terminal 300 is realized by the instruction from the CPU 301 shown in FIG. 3, the camera 312 and the imaging element I/F 313 shown in FIG. 3. The capturing unit 356 captures a plurality of objects and outputs a plurality of pieces of image data obtained by capturing the objects. The plurality of output pieces of the image data include coordinate information in the capturing area. The capturing unit 356 starts operating in response to starting the prohibited substance inclusion determination application. When the operation for capturing the label attached to the food item is performed, the capturing unit 356 recognizes the AR markers from the respective objects captured in the capturing area, and obtains the image of the respective AR marker parts. The capturing unit 356 inputs the image of the AR marker parts in the marker decoding unit 360.

The display control unit 358 is realized by the instruction from the CPU 301 shown in FIG. 3, and the display 317 shown in FIG. 3. The display control unit 358 performs control for displaying the labels attached to the respective food items when the capturing unit 356 captures the objects, and performs control for displaying an image including the plurality of superimposition images transmitted from the second server 200 in the display 317. The plurality of superimposition images are displayed in accordance with the coordinate information.

The food allergy inclusion determination request unit 362 is realized by the instruction from the CPU 301 shown in FIG. 3. After the prohibited substance inclusion determination application is started in response to an event in which the operation input reception unit 354 receives a request for starting the prohibited substance inclusion determination application by the user operating the operation button 308, the food allergy inclusion determination request unit 362 requests the food allergy inclusion determination. Specifically, the food allergy inclusion determination request unit 362 obtains the captured image of the labels from the capturing unit 356, and obtains the marker IDs from the marker decoding unit 360. Further, the food allergy inclusion determination request unit 362 causes the storage/readout unit 364 to read out the prohibited substance information management table, stored in the prohibited substance information management DB 3001 of the storage unit 3000, to obtain the prohibited substance information. The food allergy inclusion determination request unit 362 transmits, to the first server 100, the captured image of the labels, the marker IDs, and the prohibited substance information to request the first server 100 to determine whether each of the food items, to which the labels are attached respectively, includes the prohibited substance. The labels of the capturing image are associated with the corresponding marker IDs of the markers of the labels.

According to the first variation, about the plurality of food items, the image including the plurality of superimposition images in which the plurality of augmented reality images, each of which indicates whether the ingredient which is the prohibited substance is included, are superimposed on the captured image of the plurality of labels of the food items, respectively, can be displayed at once. In this way, from a remote position, the user can recognize instinctively whether the ingredient which is the prohibited substance is included for each of the food items without approaching the food items.

<Second Variation of the First Embodiment>

The above described first embodiment can be applied to an information processing system according to a second variation. However, in the second variation, the superimposition image generation unit 256 of the second server 200 shown in FIG. 4 is omitted.

In the information processing system according to the second variation, the food allergy inclusion determination request unit 362 is realized by the instruction from the CPU 301 shown in FIG. 3. After the prohibited substance inclusion determination application is started in response to an event in which the operation input reception unit 354 receives a request for starting the prohibited substance inclusion determination application by the user operating the operation button 308, the food allergy inclusion determination request unit 362 requests food allergy inclusion determination. Specifically, the food allergy inclusion determination request unit 362 obtains the marker ID from the marker decoding unit 360. Further, the food allergy inclusion determination request unit 362 causes the storage/readout unit 364 to read out the prohibited substance information management table, stored in the prohibited substance information management DB 3001 of the storage unit 3000, to obtain the prohibited substance information. The food allergy inclusion determination request unit 362 transmits, to the first server 100, the marker ID and the prohibited substance information to request the first server 100 to determine whether the food item, to which the label is attached, includes the prohibited substance.

The food allergy inclusion determination request unit 362 obtains the image, transmitted from the second server 200 as a response to the request, which indicates whether the ingredient which is the prohibited substance is included, and inputs the image in the display control unit 358. The display control unit 358 obtains the captured image of the label from the capturing unit 356 and superimposes the image which indicates whether the ingredient which is the prohibited substance is included on the obtained captured image of the label to generate and display the superimposition image.

The augmented reality image generation unit 254 of the second server 200 is realized by the instruction from the CPU 101 shown in FIG. 2, and generates the augmented reality image superimposed on the image of the food item based on the prohibited substance inclusion information transmitted by the first server 100. The augmented reality image generation unit 254 transmits the augmented reality image to the wireless communication terminal 300 from the transmission/reception unit 252. For example, in a case in which the prohibited substance inclusion information indicates that the prohibited substance is included, the augmented reality image generation unit 254 generates the augmented reality image for prompting the user to recognize instinctively that the food item includes the prohibited substance. Specifically, the augmented reality image generation unit 254 can generate the image “x” or “NG” as the augmented reality image for prompting the user to recognize instinctively that the food item includes the prohibited substance. Further, in a case in which the prohibited substance inclusion information indicates that the prohibited substance is not included, the augmented reality image generation unit 254 generates, for example, the augmented reality image for prompting the user to recognize instinctively that the food item does not include the prohibited substance. Specifically, the augmented reality image generation unit 254 can generate the image “o” or “OK” as the augmented reality image for prompting the user to recognize instinctively that the food item does not include the prohibited substance. The augmented reality image generation unit 254 may change the augmented reality image for prompting the user to recognize instinctively whether the food item includes the prohibited substance in accordance with the language which the user uses and the country.

According to the second variation, because the wireless communication terminal 300 does not transmit the captured image of the label to the first server 100, data volume transmitted to the first server 100 can be reduced. Moreover, because the superimposition image is generated in the wireless communication terminal 300, processing load of the second server 200 can be reduced.

The above described first embodiment and variations can be combined as appropriate.

<Supplement to the First Embodiment>

The first server 100, the second server 200, and the wireless communication terminal 300 according to the above described first embodiment may be structured with a single computer, or may be structured with a plurality of computers in which each unit (function or means) is divided and allocated in any manner.

Further, a recording medium such as the CD-ROM storing any one of the program for the first server 100, the program for the second server 200 and the program for the wireless communication terminal 300, a HD, a medium, a flash memory or the like storing these programs may be provided, in a domestic country or overseas, for the users as a program product.

Further, although the AR marker is recognized in the above described first embodiment, the present invention is not limited to this. A one-dimensional code such as a barcode and a two-dimensional code such as a quick response (QR) code may be used.

Further, in the above described first embodiment, the augmented reality image is superimposed in order to notify the user whether the ingredient which is the food allergy is included, however the present invention is not limited to this. Alternatively, tactile (touch) data may be used. In this case, based on a sense felt by the user touching the food item, whether the ingredient which is the prohibited substance is included is determined (notified). Further, smell data may be used for notifying the user whether the ingredient which is the prohibited substance is included. In this case, based on a smell of the food item, whether the ingredient which is the prohibited substance is included is determined (notified).

In the above described embodiment, the wireless communication terminal is an example of a communication device, and the first server 100 and the second server 200 are examples of information processing apparatuses. Further, the marker decoding unit 360 is an example of a decoding unit. The storage unit 3000 is an example of a first storage unit. The storage unit 1000 is an example of a second storage unit. The allergy information obtaining unit 154 is an example of an obtaining unit. The prohibited substance information determination unit 156 is an example of a determination unit. The augmented reality image generation unit 254 is an example of an image generation unit. Although the functional block diagrams are used for describing the apparatuses according to the embodiment for the convenience of the description, the apparatuses may be realized by hardware and/or software.

Further, the present invention is not limited to the embodiment, but various variations and modifications may be made without departing from the scope of the present invention.

The present application is based on and claims the benefit of priority of Japanese Priority Application No. 2015-072395 filed on Mar. 31, 2015, with the Japanese Patent Office, the entire contents of which are hereby incorporated by reference.

What is claimed is:

1. An information processing system comprising:
a communication device;
a first server; and
a second server;
wherein the communication device includes,
a capturing unit configured to capture a mark attached to a commodity;
a decoding unit configured to decode the mark captured by the capturing unit;
a first storage unit configured to store a substance registered by a user;
a first transmission and reception unit configured to transmit a determination request and to receive a determination response to the determination request, the determination request including substance information of the substance stored in the first storage unit and identification information of the mark obtained by the decoding unit decoding the mark; and
a display control unit configured to display an image based on image information included in the determination response,
wherein the first server includes,
a second storage unit configured to store the identification information of the mark attached to the commodity and ingredient information about an ingredient of the commodity in association with each other;
an obtaining unit configured to obtain the ingredient information about the ingredient of the commodity from the second storage unit based on the identification information of the mark included in the determination request;
a determination unit configured to determine whether the ingredient information about the ingredient of the commodity, which is obtained by the obtaining unit, includes information which matches the substance information included in the determination request; and
a transmission unit configured to transmit, to the second server, a determination result determined by the determination unit, and
wherein the second server includes,
an image generation unit configured to generate an image which indicates the determination result based on the determination result transmitted from the first server; and
a second transmission and reception unit configured to receive the determination result transmitted from the first server and to transmit, to the communication device, the determination response which includes the image information of the image generated by the image generation unit.

2. The information processing system according to claim 1,
wherein the capturing unit is configured to recognize the mark attached to a food item,
wherein the first storage unit is configured to store the substance prohibited from being taken in, the substance being registered by the user, and
wherein the second storage unit is configured to store identification information of the mark attached to the food item and ingredient information about an ingredient of the food item in association with each other.

3. The information processing system according to claim 1,
wherein the image generation unit is configured to generate the image to be displayed by superimposing augmented reality on the commodity based on the determination result, and
wherein the display control unit is configured to display the image in which the augmented reality is superimposed on the commodity.

4. The information processing system according to claim 1,
wherein the first storage unit is configured to store the substance and a permissible quantity of the substance registered by the user, and
wherein the determination unit is configured to determine whether the ingredient information of the commodity includes the information, which matches the substance information, included in the determination request, and which indicates a quantity of the substance is equal to or greater than the permissible quantity.

5. The information processing system according to claim 3, wherein the communication device includes a setting unit for setting a language to be displayed in the augmented reality.

6. An information processing apparatus comprising:
a storage unit configured to store identification information of a mark attached to a commodity and ingredient information about an ingredient of the commodity in association with each other;
an obtaining unit configured to obtain the ingredient information about the ingredient of the commodity from the storage unit based on the identification information of the mark attached to the commodity included in a determination request transmitted from a communication device;
a determination unit configured to determine whether the ingredient information about the ingredient of the commodity, which is obtained by the obtaining unit, includes information which matches substance information about a substance registered by a user included in the determination request;
an image generation unit configured to generate an image which indicates a determination result determined by the determination unit based on the determination result; and
a transmission and reception unit configured to receive the determination request transmitted from the communication device and to transmit, to the communication device, a determination response which includes image information of the image generated by the image generation unit.

7. The information processing apparatus according to claim 6, wherein the image generation unit is configured to generate the image by superimposing augmented reality on the commodity based on the determination result.

8. The information processing apparatus according to claim 6, wherein the determination unit is configured to determine whether the ingredient information of the commodity includes the information, which matches the substance information, included in the determination request, and which indicates a quantity of the substance is equal to or greater than a permissible quantity registered by the user.

9. The information processing apparatus according to claim 7, wherein the communication device includes a setting unit for setting a language used in the augmented reality.

10. An information processing method comprising:
a step of capturing a mark attached to a commodity;
a step of decoding the mark captured in the capturing step;
a step of transmitting a determination request which includes substance information of a substance registered by a user and identification information of the mark obtained in the step of decoding;
a step of receiving a determination response to the determination request; and
a step of displaying an image based on image information included in the determination response, the image indicating whether the commodity includes an ingredient which matches the substance information.

11. The information processing method according to claim 10, further comprising:
a step of storing the substance prohibited from being taken in, the substance being registered by the user.

12. The information processing system according to claim 10, wherein the substance and a permissible quantity of the substance registered by the user are stored in the step of storing.

13. The information processing system according to claim 10, wherein the image is displayed based on a language set by the user in the step of displaying.
